(19) United States
(12) Patent Application Publication
(10) Pub. No.: US 2026/0111720 A1
(43) Pub. Date: Apr. 23, 2026

(54) CHANNEL-WISE DIGITAL NOVEL NEW TRANSFORMATION-BASE ERROR CORRECTION MECHANISM FOR ENHANCING ANALOG MACHINE LEARNING CHIP OUTPUT

(71) Applicants: Yasantha Rajakarunanayake, San Ramon, CA (US); Dissanayake Vinodh Gunasekera, Houston, TX (US); Dilshan Perera, Udugampola (LK); Chamli Deshan Liyana Arachchi, Ambalantota (LK); Charitha Gunasekara, Ragama (LK); Parana Manage Kasun Tharaka, Colombo (LK); Vishal Sarin, SARATOGA, CA (US)

(72) Inventors: Yasantha Rajakarunanayake, San Ramon, CA (US); Dissanayake Vinodh Gunasekera, Houston, TX (US); Dilshan Perera, Udugampola (LK); Chamli Deshan Liyana Arachchi, Ambalantota (LK); Charitha Gunasekara, Ragama (LK); Parana Manage Kasun Tharaka, Colombo (LK); Vishal Sarin, SARATOGA, CA (US)

(21) Appl. No.: 19/057,730

(22) Filed: Feb. 19, 2025

Related U.S. Application Data
(60) Provisional application No. 63/708,261, filed on Oct. 17, 2024.

(51) Int. Cl. G06N 3/065; G06N 3/0464

(52) U.S. Cl. CPC G06N 3/065; G06N 3/0464

(57) ABSTRACT

A method for improving the accuracy of an analog machine learning system. The method comprises the step of receiving a multi-channel output data. The multi-channel output data is generated by the analog machine learning system. A correction model is applied to each channel of the multi-channel output data. The correction model comprises a transformation function parameterized by a one or more channel-specific correction parameters. The one or more channel-specific correction parameters are dynamically updated based on a comparison between an output data of the analog machine learning system and a reference output data.

### CLAIM OF PRIORITY

This application claims priority to U.S. Provisional Ser. No. 63/708,261 , filed on Oct. 17, 2024, and titled METHOD AND SYSTEM FOR CHANNEL-WISE DIGITAL AFFINE TRANSFORMATION FORENHANCING ANALOG MACHINE LEARNING CHIP OUTPUT. This provisional application is incorporated herewith by reference in its entirety.

### BACKGROUND

Analog machine learning (ML) chips are becoming increasingly relevant due to their significant power and speed advantages over traditional digital chips. These chips leverage analog computation to accelerate inference in machine learning tasks while reducing energy consumption. However, one of the major challenges of using analog ML chips is that they introduce non-linearities, noise, and signal distortions, especially when scaling computations across multiple channels. These inaccuracies can reduce the effectiveness of machine learning models, particularly in domains where precision is critical, such as image recognition, speech processing, and medical diagnostics.

Analog machine learning chips can be efficient in terms of power consumption and computational speed. However, the analog nature of these chips can introduce non-linearities, noise, and signal drift, which reduce the accuracy of machine learning models that rely on precise data inputs. Traditional methods of calibration and error correction in analog systems are either hardware-intensive or require significant post-processing, both of which negatively impact system performance. Accordingly, improvements to these issues are desired that can apply a digital affine transformation to each channel of the chip's output, correcting for distortions in real time and improving overall model accuracy without requiring additional hardware changes.

### SUMMARY OF THE INVENTION

In one aspect, a method for improving the accuracy of an analog machine learning system. The method comprises the step of receiving a multi-channel output data. The multi-channel output data is generated by the analog machine learning system. A correction model is applied to each channel of the multi-channel output data. The correction model comprises a transformation function parameterized by a one or more channel-specific correction parameters. The one or more channel-specific correction parameters are dynamically updated based on a comparison between an output data of the analog machine learning system and a reference output data.

In another aspect, a system for improving the accuracy of an analog machine learning system includes an analog machine learning chip configured to produce a multi-channel output data. A processing unit configured to apply a correction model to each channel of the output data. The correction model comprises a transformation function. A feedback mechanism configured to dynamically adjust one or more parameters of the correction model based on one or more performance metrics of the analog machine learning system.

### BRIEF DESCRIPTION OF THE DRAWINGS

FIG. 1 illustrates an example process for channel-wise digital novel new transformation-base error correction mechanism for enhancing analog machine learning chip output, according to some embodiments.

FIG. 2 illustrates an example system for applying a digital Affine transformation to each channel of the analog machine learning chip.

FIG. 3 illustrates an example Affine Transformation Model, according to some embodiments.

FIG. 4 illustrates an example process for implementing Affine Transformation Model, according to some embodiments.

FIG. 5 illustrates an example process for performing Channel-wise Output Extraction, according to some embodiments.

FIG. 6 illustrates an example dynamic feedback look mechanism, according to some embodiments.

FIG. 7 illustrates an example process showing integration with CNN architectures, according to some embodiments.

FIG. 8 illustrates an example affine transform 2D case, according to some embodiments.

FIG. 9 illustrates an example process for Signal-to-Noise Ratio (SNR) Compensation and Optimization, according to some embodiments.

FIG. 10 illustrates an example equation for signal value calculation, according to some embodiments.

FIG. 11 illustrates an example equation for defining noise, according to some embodiments.

FIG. 12 shows an example equation for calculating the logarithmic ratio of the signal to the noise, according to some embodiments.

FIG. 13 illustrates an example Optimization Process, according to some embodiments.

FIG. 14 illustrates an example process for improving the accuracy of an analog machine learning chip, according to some embodiments.

FIG. 15 illustrates an example system for improving the accuracy of an analog machine learning chip, according to some embodiments.

FIG. 16 illustrates an example process for enhancing analog machine learning chip output accuracy, according to some embodiments.

FIG. 17 illustrates an example process for improving the accuracy of an analog machine learning system, according to some embodiments.

The Figures described above are a representative set and are not exhaustive with respect to embodying the invention.

### DESCRIPTION

Disclosed are a system, method, and article for channel-wise digital novel new transformation-base error correction mechanism for enhancing analog machine learning chip output. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Analog machine learning chips are specialized hardware devices designed to perform AI computations using analog electronics rather than traditional digital circuits. Analog machine learning chips can leverage the continuous nature of analog signals to perform neural network operations like matrix multiplication and activation functions directly in the analog domain, potentially offering significant improvements in energy efficiency and speed compared to digital implementations. Analog machine learning chips can utilize the physical properties of electronic components such as resistive elements or memristors, analog chips can perform many computations in parallel with lower power consumption.

Convolutional Neural Networks (CNNs) are a class of deep learning models particularly effective for processing grid-like data, such as images. They use convolutional layers to automatically and adaptively learn spatial hierarchies of features from input data, typically followed by pooling layers for down sampling and fully connected layers for final classification or regression tasks. CNNs can leverage local connectivity patterns and parameter sharing to efficiently handle high-dimensional inputs while reducing the number of learnable parameters compared to traditional fully connected networks.

Digital affine transformations are mathematical operations used in computer graphics and image processing to modify digital images or geometric shapes. These transformations preserve straight lines and parallelism, and can include operations such as translation, rotation, scaling, and shearing. In a 2D space, an affine transformation can be represented by a 2×3 matrix, allowing for efficient computation and composition of multiple transformations. Example applications include image resizing, perspective correction, and creating visual effects in digital media. While affine transformations are linear in nature, they can be extended to handle more complex non-linear transformations by using techniques like piece-wise affine transformations or higher-dimensional spaces.

Fully Convolutional Network (FCN) adapts convolutional neural networks by replacing the final fully connected layers with convolutional layers to enable pixel-level predictions across entire images. FCNs can utilize skip connections that combine deep, semantic information from later layers with fine, local information from earlier layers to produce detailed segmentation maps. The network architecture allows for input of any size since convolutional layers operate locally and preserve spatial information throughout the network. FCNs achieve efficient training and inference by sharing computation through their fully convolutional design, enabling dense prediction tasks like semantic segmentation, where each pixel must be classified.

Neural network (e.g. an artificial neural network) is a model inspired by the structure and function of biological neural networks found in the brain. It consists of connected units or nodes called artificial neurons. These are linked by edges, which model the synapses in a biological brain. Each artificial neuron receives signals from its connected neurons, then processes these inputs using a nonlinear function known as the activation function, and outputs a signal, typically represented as a real number, to other connected neurons. The strength and influence of the connections, represented by weights, are adjustable and are refined during the network's learning process to optimize performance.

### EXAMPLE SYSTEMS AND METHODS

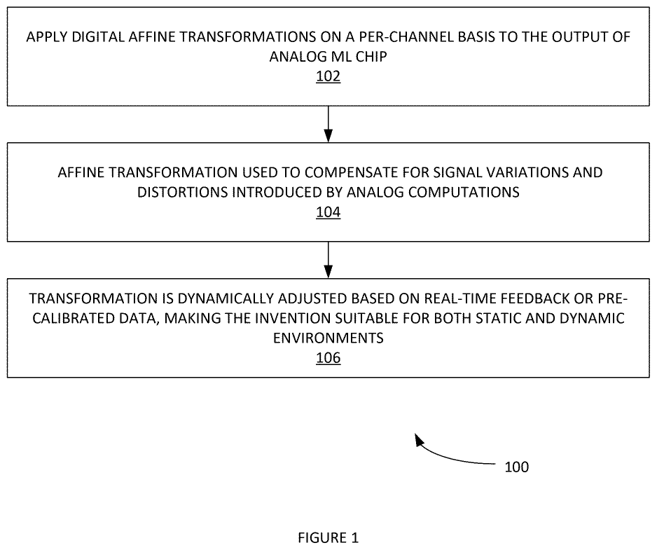

FIG. 1 illustrates an example process 100 for channel-wise digital novel new transformation-base error correction mechanism for enhancing analog machine learning chip output, according to some embodiments. Process 100 can apply digital affine transformations, by way of example of a channel-wise digital novel new transformation-base error correction mechanism for enhancing analog machine learning chip output, on a per-channel basis to the output of analog machine learning (ML) chips in step 102. In step 104, the affine transformation is used to compensate for signal variations and distortions introduced by analog computations, thereby improving the accuracy and performance of machine learning models. In step 106, the transformation is dynamically adjusted based on real-time feedback or pre-calibrated data, making the invention suitable for both static and dynamic environments. Process 100 allows for precise output control while maintaining the inherent speed and power efficiency of analog computation. It is noted as that used herein, an affine transformation is used as an example of a channel-wise digital novel new transformation-base error correction mechanism for enhancing analog machine learning chip output, and other types of transformations can be used in other example embodiments.

It is noted that process 100 is especially suited for machine learning models that depend on precise channel-wise data, such as Convolutional Neural Networks (CNNs) and Fully Connected Networks (FCNs). Process 100 can apply a digital affine transformation to each channel of the analog machine learning chips output to correct for distortions in real time and improve overall model accuracy without requiring additional hardware changes.

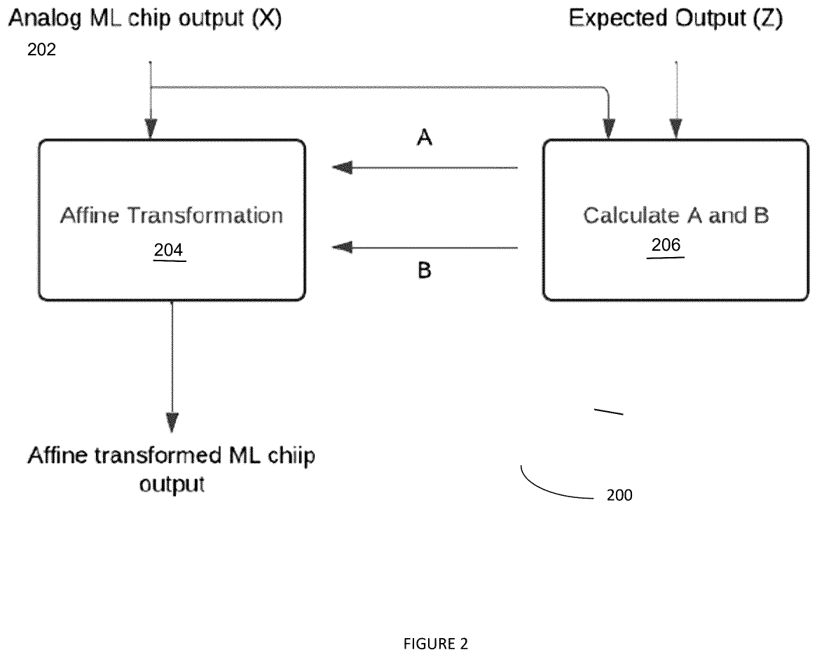

FIG. 2 illustrates an example system 200 for applying a digital affine transformation to each channel of the analog machine learning chip. System 200 can be used for applying digital affine transformations to enhance analog machine learning chip output. System 200 can include three main components arranged in a processing pipeline: An Analog ML chip 202 that produces the initial output (X). A calculation module 206 that computes parameters A and B for the transformation. An Affine Transformation unit 204 that applies these parameters to produce the transformed ML chip output. System 200 flow shows that a raw analog ML chip output (X) is sent to both the parameter calculation module and the Affine Transformation unit 204. The calculation module 206 determines the appropriate A and B parameters for the transformation. These parameters are fed into the Affine Transformation unit 204. The Affine Transformation unit 204 applies the transformation T(x)=Ax+B to produce the enhanced output. This setup enables real-time correction of distortions and non-linearities introduced by the analog computation process (e.g. as described supra). The design allows for channel-wise processing of the analog chip's output, improving overall accuracy while maintaining the efficiency advantages of analog computation.

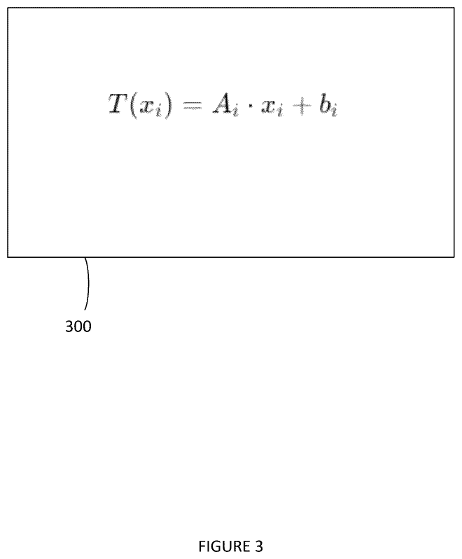

FIG. 3 illustrates an example Affine Transformation Model, according to some embodiments. Affine Transformation Model 300 can be utilized by process 100 and/or system 200. Affine Transformation Model 300 can be applied to each individual output channel of the analog ML chip. The affine transformation is represented mathematically. More specifically, T(xᵢ) represents the transformed output of the i^{th} channel. Aᵢ is a matrix (or scalar in simpler cases) that defines the linear transformation for the i^{th} channel. It can include operations such as scaling, rotation, or shearing, depending on the distortions observed in the analog output. xᵢ is the raw output of the i^{th} channel from the analog ML chip. bᵢ is a vector or scalar that represents the translation or bias applied to the output of the i^{th} channel.

Furthermore, the parameters Aᵢ and Bᵢ for each channel are derived based on either pre-calibrated data or real-time feedback mechanisms. These parameters are dynamically adjustable to ensure optimal compensation for channel-specific errors, such as gain variation, signal drift, or cross-channel interference.

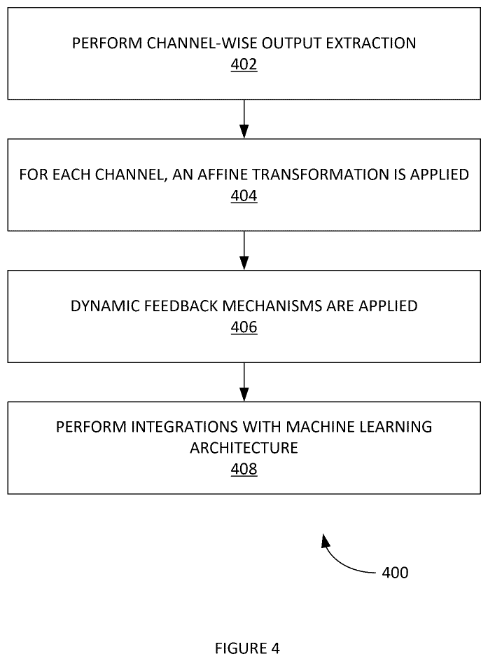

FIG. 4 illustrates an example process 400 for implementing Affine Transformation Model, according to some embodiments. In step 402, process 400 can perform Channel-wise Output Extraction.

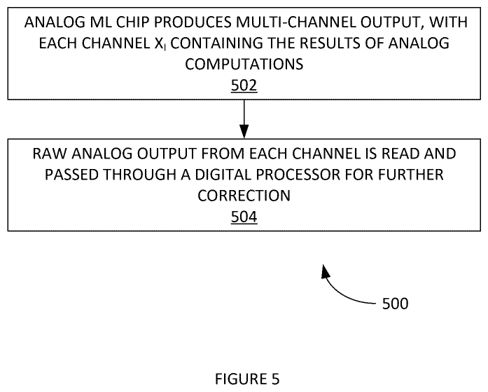

FIG. 5 illustrates an example process 500 for performing Channel-wise Output Extraction, according to some embodiments. In step 502, the analog ML chip produces multi-channel output, with each channel xᵢ containing the results of analog computations such as convolutional layers in a deep learning model. The raw analog output from each channel is read and passed through a digital processor for further correction in step 504.

Returning process 400, in step 404, for each channel, an affine transformation is applied. The affine transformation can be as defined by T(xᵢ)=Aᵢ·xᵢ+bᵢ. This transformation corrects the distortions introduced by analog components. For example, if the gain of the i^{th} channel is off due to noise or non-linearity, the scaling part of the matrix Ai will adjust it back to the correct range. Similarly, if there is a bias in the signal, bi will shift the output to compensate for that.

In step 406, Dynamic Feedback mechanisms are applied. Process 400 continuously monitors the output accuracy of the machine learning model. If deviations are detected, feedback mechanisms dynamically adjust the affine transformation parameters Aᵢ and bi to maintain high accuracy. The feedback can be derived from the loss function of the model, or other performance metrics (e.g. signal-to-noise ratio (SNR), model accuracy, etc.).

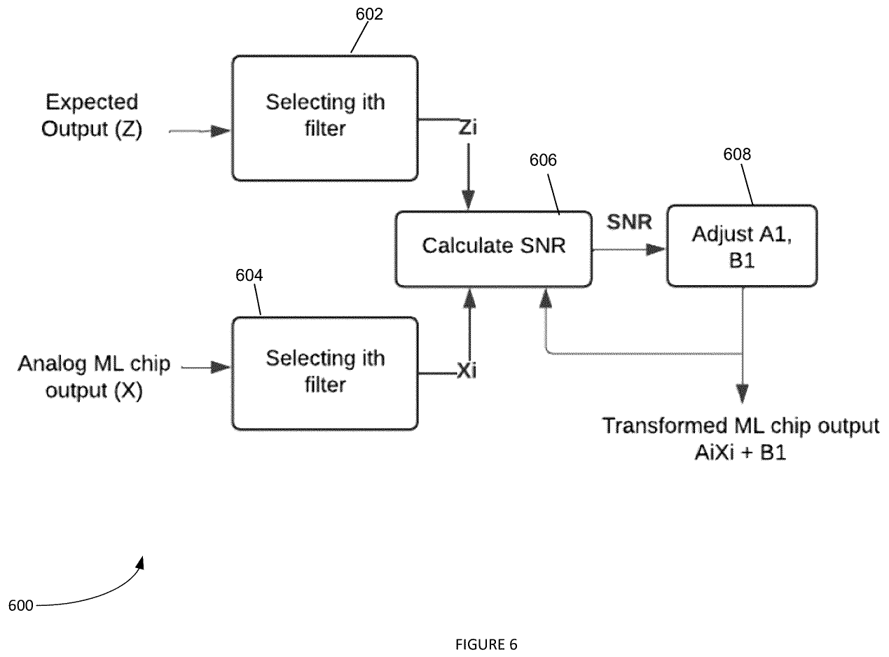

FIG. 6 illustrates an example dynamic feedback look mechanism 600, according to some embodiments. Dynamic feedback look mechanism 600 can be leveraged by process 400. More specifically, dynamic feedback look mechanism 600 illustrates a dynamic feedback loop mechanism for optimizing analog ML chip output through affine transformations.

Dynamic feedback look mechanism 600 can include four main components in a feedback system. This can include two Selecting i^{th} filter blocks 602-604 receiving: Analog ML chip output (X) and Expected output (Z).

A Calculate SNR block 606 that receives filtered outputs from both selecting blocks (Xi and Zi) can be provided. Calculate SNR block 606 computes the signal-to-noise ratio between actual and expected outputs.

An Adjust A1, B1 block 608 receives the SNR from the calculation block. Adjust A1, B1 block 608 adjusts the affine transformation parameters (A and B). Adjust A1, B1 block 608 outputs the adjusted parameters to the transformed ML chip output.

Dynamic feedback look mechanism 600 includes a feedback loop where the transformed output (AXi+B1) feeds back into the system. The SNR is used to continuously optimize the transformation parameters.

Dynamic feedback look mechanism 600 describes how the dynamic feedback mechanism continuously monitors output accuracy and adjusts transformation parameters based on performance metrics like SNR. The mechanism ensures real-time optimization of the affine transformation to maintain high accuracy of the analog ML chip output.

In step 408, process 400 can perform Integrations with Machine Learning Architecture. Process 400 can work seamlessly with popular neural network architectures such as ResNet and YOLO (by way of example), where small errors in the analog output can lead to significant drops in overall performance. The per-channel transformation ensures that the final outputs from these analog ML chips closely match the expected results from a purely digital system.

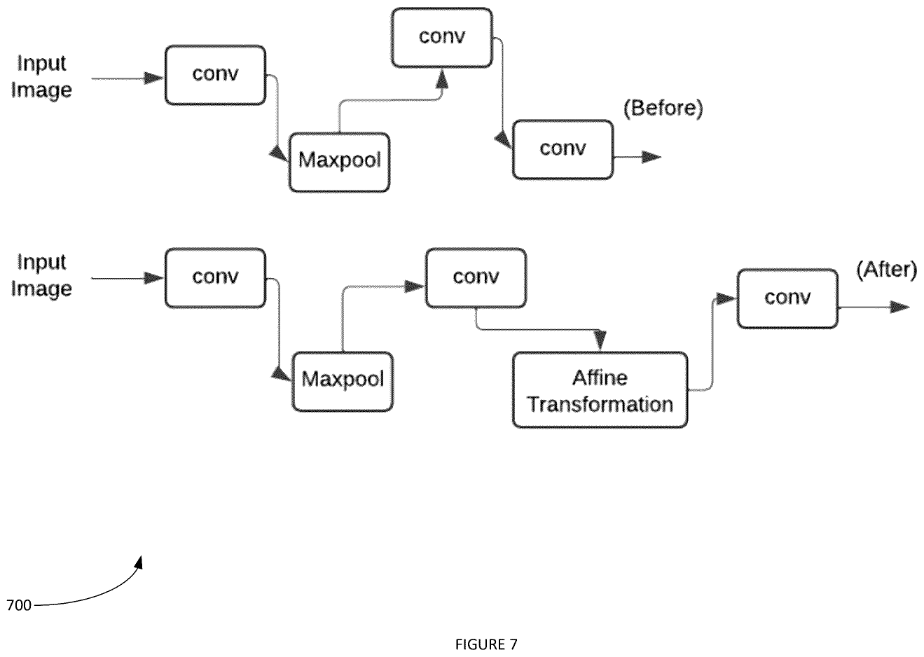

FIG. 7 illustrates an example process 700 showing integration with CNN architectures, according to some embodiments.

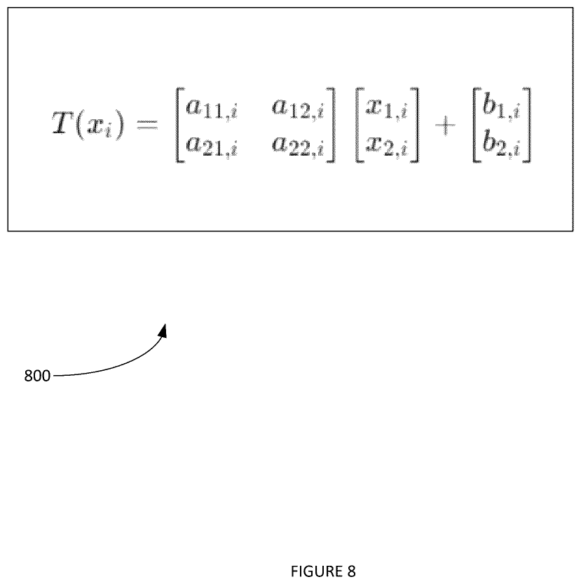

FIG. 8 illustrates an example Affine Transform 2D Case 800, according to some embodiments. Here, a_{i is a} 2×2 matrix that combines scaling, rotation, and shearing transformations for two-dimensional data. For multi-dimensional data, the matrix can be extended appropriately. x_{1,i}, x_{2,i} represent the raw values of the i^{th} channel output in two dimensions (e.g. pixel coordinates in image data). b_{1,i,} b_{2,i} are the translation components.

Dynamic Adjustment via Optimization is now discussed. It is noted that the affine transformation parameters can be optimized using real-time feedback, leveraging optimization techniques such as gradient descent, where the system minimizes the error between the transformed outputs and the target model outputs. This allows for adaptive correction based on the operational environment, reducing error caused by voltage drifts or thermal noise. When the SNR of a channel drops below a predefined threshold, the system adjusts the affine transformation parameters to improve accuracy.

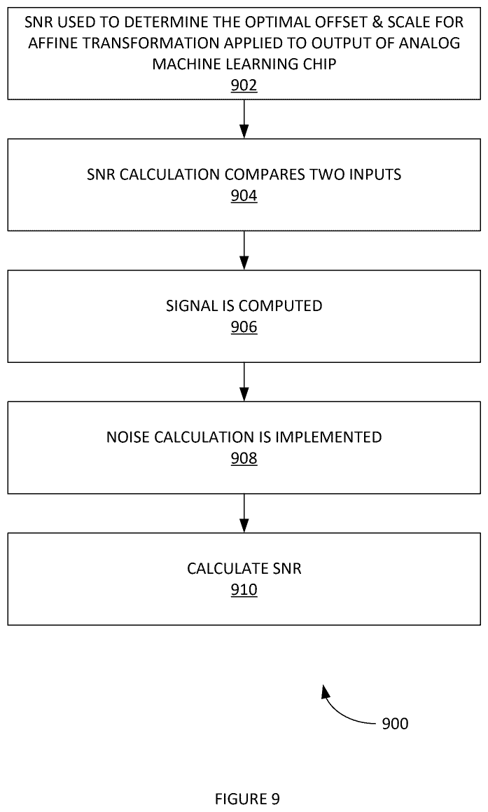

FIG. 9 illustrates an example process 900 for Signal-to-Noise Ratio (SNR) Compensation and Optimization, according to some embodiments. The Signal-to-Noise Ratio (SNR) is a key metric used to determine the optimal offset and scale for the affine transformation applied to the output of the analog machine learning chip in step 902. Process 900 enhances each channel's accuracy by compensating for noise and signal distortions introduced during analog computation. In step 904, the SNR calculation compares two inputs. The first input can be Hardware output (hw_tensor), which represents the raw output from the analog machine learning chip. A second input can be Quantized output (asm_tensor), which is the quantized result from the analog signal model (ASM).

In step 906, the signal can be computed. The signal is computed as the mean squared value of the elements in the hardware output tensor. Let h=[h₁, h₂, h₃, . . . h_{N}] represent the elements of the hw_tensor.

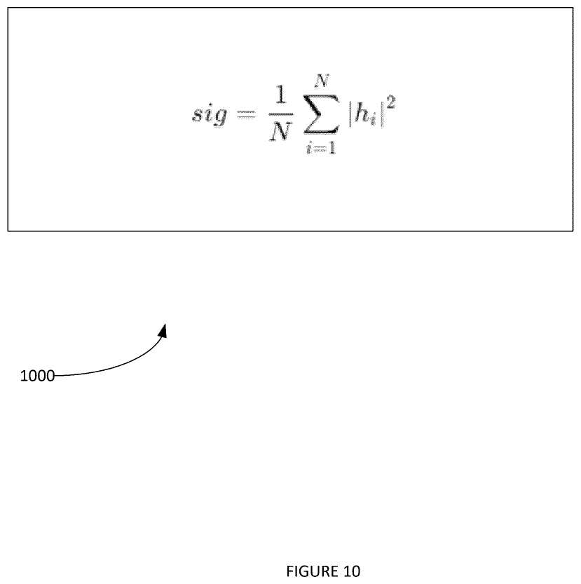

FIG. 10 illustrates an example equation 1000 for signal value calculation, according to some embodiments. Here, hᵢ are the individual elements from h_{w} tensor. |hᵢ|² is the square of the absolute difference between the two tensors'elements. N is the total number of elements in the tensors. This formula calculates the average signal power across all elements of the hw_tensor.

In step 908, Noise Calculation can be implemented. The noise can be computed as the mean squared difference between the corresponding elements of the hardware output hw_tensor and the quantized output asm_tensor. Here, a=[a1, a2, . . . aN] can represent the elements of the asm_tensor.

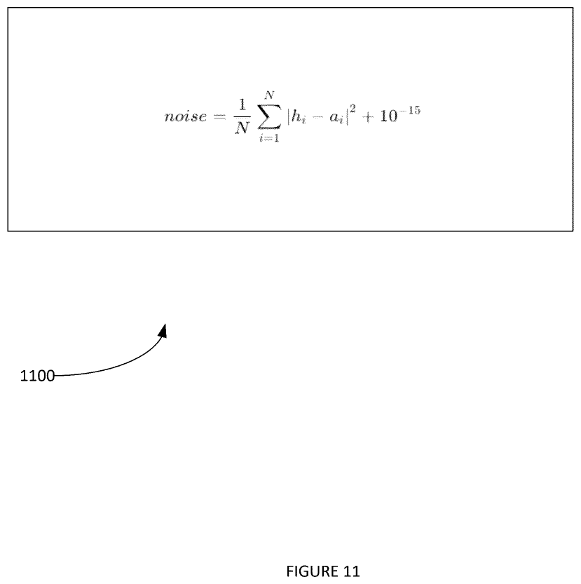

FIG. 11 illustrates an example equation 1100 for defining noise, according to some embodiments. Where, hᵢ and aᵢ are the corresponding elements from h_{w} tensor. |hᵢ−aᵢ|² is the square of the absolute difference between the two tensors'elements. N is the total number of elements in the tensors. This computation estimates the deviation between the hardware output and the expected quantized output, with a small constant added to prevent division by zero in the subsequent steps.

In step 910, calculates SNR. Finally, the SNR is computed as the logarithmic ratio of the signal to the noise. This ratio reflects the quality of the hardware output by quantifying the level of noise relative to the signal. The higher the SNR, the better the signal quality and the more accurate the affine transformation.

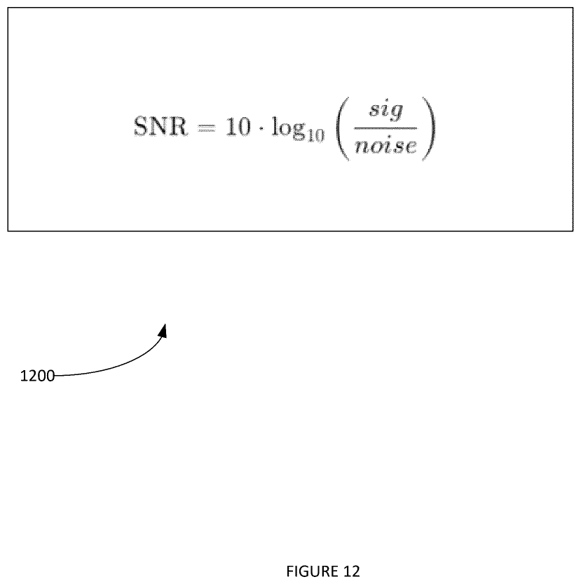

FIG. 12 shows an example equation 1200 for calculating the logarithmic ratio of the signal to the noise, according to some embodiments.

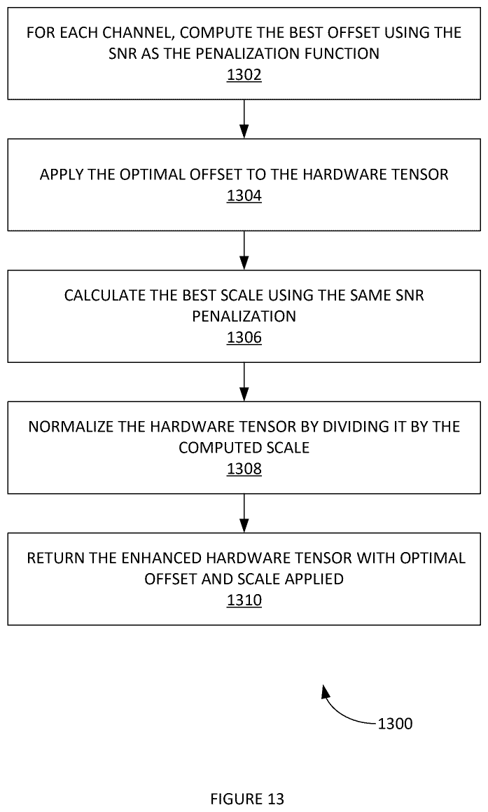

FIG. 13 illustrates an example Optimization Process 1300, according to some embodiments. The calculated SNR serves as a penalization function to optimize the offset and scale for each channel of the hardware output. Maximizing the SNR helps identify the optimal parameters to enhance the accuracy of the hardware tensor. In step 1302, for each channel, compute the best offset using the SNR as the penalization function. In step 1304, process 1300 can apply the optimal offset to the hardware tensor. In step 1306, process 1300 can calculate the best scale using the same SNR penalization. In step 1308, process 1300 can normalize the hardware tensor by dividing it by the computed scale. In step 1310, process 1300 can return the enhanced hardware tensor with optimal offset and scale applied. This channel-wise optimization process ensures that the affine transformation compensates for signal distortions, resulting in improved accuracy for machine learning models.

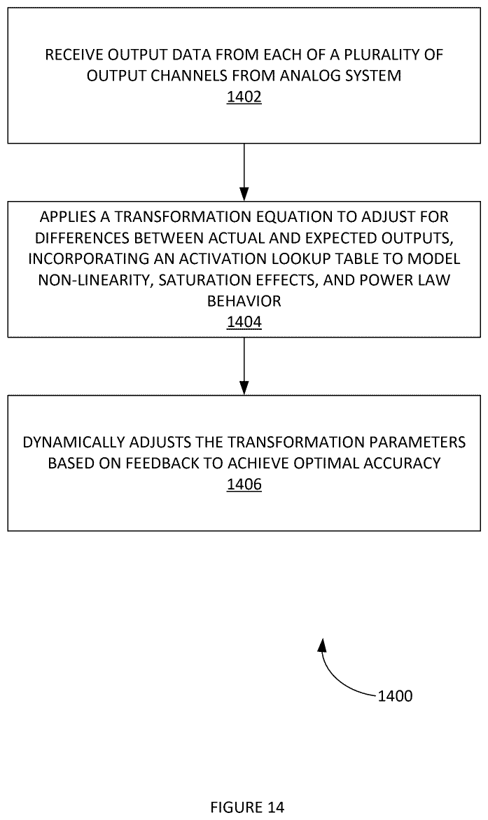

FIG. 14 illustrates an example process 1400 for improving the accuracy of an analog machine learning chip, according to some embodiments. In step 1402, process 1400, receives output data from each of a plurality of output channels from the analog system. In step 1404, process 1400 applies a transformation equation to adjust for differences between actual and expected outputs, incorporating an activation lookup table to model non-linearity, saturation effects, and power law behavior. In step 1406, process 1400 dynamically adjusts the transformation parameters based on feedback to achieve optimal accuracy. The transformation is a linear affine transformation and can be represented as T(xᵢ)=Aᵢ·xᵢ+bᵢ applying per-channel bias and scale adjustments to compensate for signal distortions. The feedback mechanism optimizes transformation parameters to account for channel-specific non-linearities and signal variations. The affine transformation compensates for gain variation, noise, and drift in the analog output.

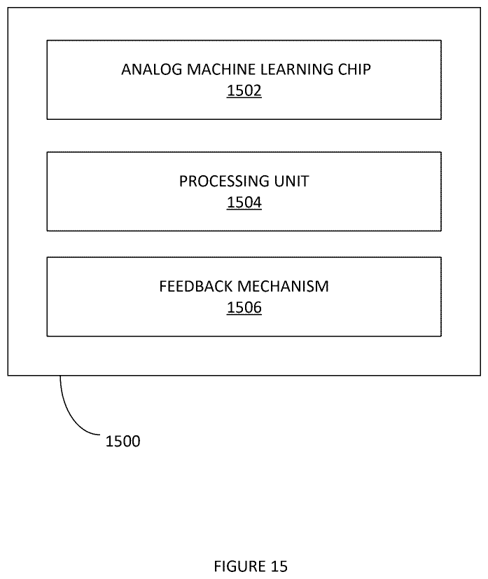

FIG. 15 illustrates an example system 1500 for improving the accuracy of an analog machine learning chip, according to some embodiments. System 1500 can process data using an analog machine learning chip. An analog machine learning chip 1502 can be configured to generate multi-channel output data. A processing unit 1504 can be configured to apply a transformation equation to correct distortions on each channel. A feedback mechanism 1506 can be configured for dynamically adjusting transformation parameters to improve accuracy.

System 1500 can provide a novel and efficient method for improving the accuracy of analog machine learning chips by applying a digital affine transformation on a per-channel basis. System 1500 compensates for non-linearities, noise, and signal distortions that naturally occur in analog circuits, thereby enhancing the performance of machine learning models without significant computational or power overhead. By dynamically adjusting the affine transformation parameters through feedback mechanisms, System 1500 ensures continuous, real-time optimization. This makes System 1500 particularly suited for high-performance machine learning applications, such as image recognition and data-driven analytics, where precision is critical. The integration of the invention with popular neural network architectures (e.g. ResNet, YOLO, etc.) highlights the adaptability and practical value of System 1500 across a wide range of industries, from autonomous vehicles to medical imaging.

The method's and system's provided herein provide scalability and minimal hardware modifications that allow for seamless adoption, positioning this invention as a key improvement in the evolution of analog ML chips. As the need for faster, more energy-efficient machine learning accelerators grows, this invention offers a timely and impactful solution that bridges the gap between analog speed and digital accuracy.

In conclusion, this invention provides a significant advancement in analog ML chip architecture by introducing an elegant, real-time, and per-channel approach to error correction through affine transformations, delivering both accuracy and efficiency.

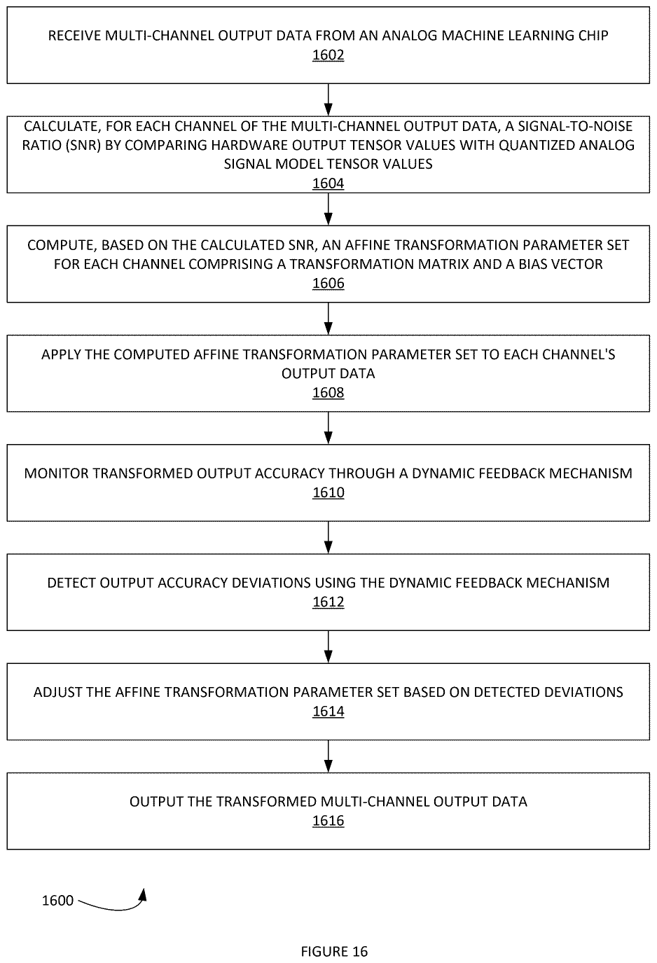

FIG. 16 illustrates an example process 1600 for enhancing analog machine learning chip output accuracy, according to some embodiments. In step 1602, process 1600 receives multi-channel output data from an analog machine learning chip. In step 1604, process 1600 calculates, for each channel of the multi-channel output data, a signal-to-noise ratio (SNR) by comparing hardware output tensor values with quantized analog signal model tensor values. In step 1606, process 1600 computes, based on the calculated SNR, an affine transformation parameter set for each channel comprising a transformation matrix and a bias vector. In step 1608, process 1600 applies the computed affine transformation parameter set to each channel's output data. In step 1610, process 1600 monitors transformed output accuracy through a dynamic feedback mechanism. In step 1612, process 1600 detects output accuracy deviations using the dynamic feedback mechanism. In step 1614, process 1600 adjusts the affine transformation parameter set based on detected deviations. In step 1616, process 1600 outputs the transformed multi-channel output data.

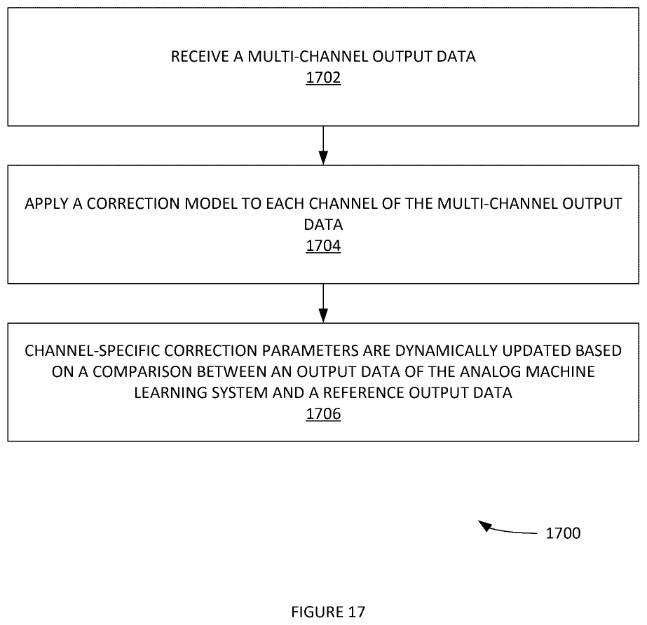

FIG. 17 illustrates an example process 1700 for improving the accuracy of an analog machine learning system, according to some embodiments. In step 1702, process 1700 receives a multi-channel output data. The multi-channel output data is generated by the analog machine learning system. A correction model is applied to each channel of the multi-channel output data in step 1704. The correction model can include a transformation function parameterized by a one or more channel-specific correction parameters. The one or more channel-specific correction parameters are dynamically updated based on a comparison between an output data of the analog machine learning system and a reference output data in step 1706.

Analog machine learning system can be a system that uses analog signals and components to perform machine learning tasks, as opposed to purely digital systems. The multi-channel output data can be data produced by the Analog machine learning system with multiple channels, where each channel represents a distinct output signal or feature. The correction model can be a computational model used to adjust and refine the output data to improve system performance. The transformation function can be a mathematical function applied to the data. This can modify its form or scale based on specific parameters. Channel-specific correction parameters can be parameters unique to each data channel used in the transformation function to fine-tune the adjustments. Dynamically updating steps can continuously and/or iteratively modify parameters during operation based on new data or feedback. Reference output data can be an ideal and/or an expected output used as a benchmark to evaluate the system's performance.

An affine transformation can be linear transformation followed by a translation, represented mathematically as T(x)=A·x+B. The scaling matrix (A) can be matrix that scales the input data. The bias vector (B) can be a vector added to the scaled input to adjust its value. The multi-channel input (x) can be the input data from multiple channels to be transformed.

Performance metrics can be quantitative measures used to evaluate the accuracy and effectiveness of the system. A Signal-to-noise ratio (SNR) can be a measure for comparing the level of the desired signal to the level of noise. Mean squared error (MSE) can be the average squared difference between the system's output and the reference output. The correlation coefficient(s) can be a statistical measure(s) indicating the strength and direction of the relationship between the system's output and reference output.

A feedback optimization process can be a method of refining system parameters based on feedback about its performance. A real-time monitoring can continuously observe performance metrics during system operation.

Non-linear components can be elements that allow the transformation function to include non-linear adjustments to enable more complex modifications. A piecewise or higher-order transformation function can be a transformation that applies different functions to different ranges of input or includes terms beyond simple linear ones for enhanced precision. Hardware-induced distortions can be unwanted alterations in signal or data caused by imperfections in the hardware. Signal drift can include gradual changes in signal output over time. Noise can include random fluctuations or interference in the signal. Gain variations can include changes in amplification levels across channels.

Example components to implement process 1700 are now discussed. An analog machine learning chip can be hardware component designed to perform machine learning computations using analog signals. A processing unit can be a computational component that applies the correction model to the data. A feedback mechanism can be a system that adjusts the correction model parameters based on performance metrics to improve accuracy.

Non-linear corrections are now discussed. These can include adjustments involving transformations that are not strictly linear, adding flexibility to the correction model. Process 1700 can use both affine transformations and non-linear corrections together. A gradient descent can be an optimization algorithm that adjusts parameters iteratively to minimize errors. Other optimization techniques can be utilized. These can be methods used to find the best set of parameters for a given objective, such as minimizing performance error.

Channel-specific correction parameters are now discussed. Channel-specific correction parameters can be correction parameters tailored to each individual channel of multi-channel data. In systems producing outputs across multiple channels, each channel might have unique characteristics, distortions, or noise levels. Therefore, the correction model for process 1700 can apply adjustments specific to each channel. For example, if there are multiple data channels (e.g., x1,x2,x3), each channel might have: Its own scaling factor or matrix (e.g., A1,A2,A3) with its own bias vector (e.g., B1,B2,B3). By using channel-specific correction parameters, the model ensures that corrections are customized for the unique needs of each channel, resulting in better overall system performance. A example key distinction for correction parameters can be as follows. It is noted that general parameters can adjust the data as a whole or for the entire system. Channel-Specific Correction Parameters can be parameters that are individualized for each channel in a multi-channel output system to address channel-specific issues.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A method for improving the accuracy of an analog machine learning system, comprising:
receiving a multi-channel output data, wherein the multi-channel output data is generated by the analog machine learning system;
applying a correction model to each channel of the multi-channel output data, wherein the correction model comprises a transformation function parameterized by a one or more channel-specific correction parameters; and
dynamically updating the one or more channel-specific correction parameters based on a comparison between an output data of the analog machine learning system and a reference output data.

2. The method of claim 1, wherein the correction model comprises an affine transformation.

3. The method of claim 2, wherein the affine transformation is represented as:
T(x)=A·x+B, and
wherein A is a scaling matrix, x is the multi-channel output data, and B is a bias vector.

4. The method of claim 3, wherein the comparison between output data of the analog machine learning system and the reference output data utilizes the one or more performance metrics.

5. The method of claim 4, wherein the one or more performance metrics comprises a signal-to-noise ratio (SNR) value, a mean squared error (MSE) value, or correlation coefficient.

6. The method of claim 5, wherein the one or more channel-specific correction parameters are dynamically updated through a feedback optimization process.

7. The method of claim 6, wherein the feedback optimization process leverages a real-time monitoring of the one or more performance metrics.

8. The method of claim 7, wherein the affine transformation is extended to comprise a plurality of non-linear components.

9. The method of claim 8 further comprising:
enabling a piecewise or higher-order transformation function for improved accuracy; and
using the dynamically updated one or more channel-specific correction parameters to optimize an overall accuracy of the analog machine learning system.

10. The method of claim 9, wherein the analog machine learning system is integrated with a neural network architectures.

11. The method of claim 9, wherein the neural network architecture comprises one or more convolutional neural networks (CNNs).

12. The method of claim 9, wherein the neural network architecture comprises a one or more fully connected networks (FCNs).

13. The method of claim 9 further comprising:
dynamically compensating for hardware-induced distortions.

14. The method of claim 13, wherein the hardware-induced distortion comprises a signal drift distortion, a noise distortion, or a gain variation across one or more channels.

15. A system for improving the accuracy of an analog machine learning system, comprising:
an analog machine learning chip configured to produce a multi-channel output data;
a processing unit configured to apply a correction model to each channel of the output data, wherein the correction model comprises a transformation function; and
a feedback mechanism configured to dynamically adjust one or more parameters of the correction model based on one or more performance metrics of the analog machine learning system.

16. The system of claim 15, wherein the correction model comprises an affine transformation.

17. The system of claim 15, wherein the correction model comprises a non-linear correction.

18. The system of claim 15, wherein the feedback mechanism optimizes a transformation parameter of the transformation function using an optimization technique to minimize a performance error of the analog machine learning system.

19. The system of claim 18, wherein the optimization technique comprises a gradient descent optimization technique.

20. The system of claim 19, wherein the analog machine learning system uses a plurality of analog signals and components to perform a specified machine learning task.
